(19) United States
(12) Patent Application Publication
(10) Pub. No.: US 2025/0323428 A1
(43) Pub. Date: Oct. 16, 2025

(54) SATELLITE MOBILE COMMUNICATION DEVICE AND SATELLITE COMMUNICATION SYSTEM

(71) Applicant: MING-TSUNG CHEN, Taipei City (TW)

(72) Inventor: MING-TSUNG CHEN, Taipei City (TW)

(21) Appl. No.: 19/178,981

(22) Filed: Apr. 15, 2025

(30) Foreign Application Priority Data
Apr. 16, 2024 (TW) 113114048

(51) Int. Cl. H01Q 21/20; H01Q 1/20

(52) U.S. Cl. CPC H01Q 21/205; H01Q 1/20

(57) ABSTRACT

A satellite mobile communication device and a satellite communication system. The satellite mobile communication device includes a base seat, a first control circuit, a first antenna module, a first connection module, and a top cover. The first control circuit is disposed on the base seat. The first antenna module is disposed on a side of the first control circuit, and is electrically connected to the first control circuit. The first connection module is connected to the first control circuit. A first predetermined distance is defined between the first control circuit and the first antenna module. The top cover is disposed on the base seat. The first connection module is connected to the satellite communication circuit.

### CROSS-REFERENCE TO RELATED PATENT APPLICATION

This application claims the benefit of priority to Taiwan Patent Application No. 113114048, filed on Apr. 16, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a satellite mobile communication device and a satellite communication system, and more particularly to a satellite mobile communication device and a satellite communication system that are low in costs.

### BACKGROUND OF THE DISCLOSURE

A satellite mobile communication device or a satellite communication system usually has a large volume and a bulky setup to achieve an appropriate communication effect, thereby incurring high costs. Therefore, how to overcome the above-mentioned problems through structural improvements, so as to reduce the costs and enhance communication performance of the satellite mobile communication device or the satellite communication system, has become one of the important issues to be solved in the relevant industry.

### SUMMARY OF THE DISCLOSURE

In response to the above-referenced technical inadequacies, the present disclosure provides a satellite mobile communication device and a satellite communication system.

In order to solve the above-mentioned problems, one of the technical aspects adopted by the present disclosure is to provide a satellite mobile communication device for receiving a satellite communication signal of a satellite. The satellite mobile communication device is connected to a satellite communication circuit, and includes a base seat, a first control circuit, a first antenna module, a first antenna module, a first connection module, and a top cover. The first control circuit is disposed on the base seat. The first antenna module is disposed on a side of the first control circuit, and is electrically connected to the first control circuit. The first connection module is connected to the first control circuit, and a first predetermined distance is defined between the first control circuit and the first antenna module. The top cover is disposed on the base seat. The first connection module is connected to the satellite communication circuit.

In order to solve the above-mentioned problems, another one of the technical aspects adopted by the present disclosure is to provide a satellite communication system for receiving a satellite communication signal of a satellite. The satellite communication system includes a satellite communication circuit, a first satellite mobile communication device, and a second satellite mobile communication device. The first satellite mobile communication device is connected to the satellite communication circuit. The second satellite mobile communication device is connected to the first satellite mobile communication device and the satellite communication circuit. According to an information amount of the satellite communication signal of the satellite, the satellite communication circuit determines whether the first satellite mobile communication device and the second satellite mobile communication device are each operated in an uplink channel mode or a downlink channel mode.

In order to solve the above-mentioned problems, yet another one of the technical aspects adopted by the present disclosure is to provide a satellite mobile communication device for receiving a satellite communication signal of a satellite. The satellite mobile communication device is connected to a satellite communication circuit, and at least includes a base seat, an antenna support, a first control circuit, a plurality of antenna modules, and a top cover. The antenna support is disposed on the base seat. The first control circuit is disposed on the base seat. One of the plurality of antenna modules is disposed on a top side of the antenna support, and other ones of the plurality of antenna modules are disposed at a periphery of the antenna support. The top cover is disposed on the base seat.

Therefore, the satellite mobile communication device and the satellite communication system provided by the present disclosure can effectively reduce implementation costs for mobile satellite communication. The satellite mobile communication device can determine one of a plurality of antennas to receive a satellite signal of the satellite through three-dimensional arrangement of the antennas and calculation of antenna signal intensities of the antennas. Furthermore, through implementation of multiple satellite mobile communication devices, the satellite communication system of the present disclosure can determine whether each satellite mobile communication device cooperatively controls communication transmission of a mobile communication system in the uplink channel mode or the downlink channel mode, so as to improve communication efficiency.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a satellite communication system that cooperates with a satellite mobile communication device according to a first embodiment of the present disclosure;

FIG. 2 is a schematic view of the satellite mobile communication device according to the first embodiment of the present disclosure;

FIG. 3 is a schematic exploded view of the satellite mobile communication device according to the first embodiment of the present disclosure;

FIG. 4 is a block diagram of the satellite mobile communication device according to the first embodiment of the present disclosure;

FIG. 5 is a schematic exploded view of the satellite mobile communication device according to a second embodiment the present disclosure;

FIG. 6 is a block diagram of the satellite mobile communication device according to the second embodiment of the present disclosure;

FIG. 7 is a schematic view of the satellite communication system according to a third embodiment of the present disclosure;

FIG. 8 is a schematic view of the satellite communication system according to a fourth embodiment of the present disclosure; and

FIG. 9 is a schematic view of the satellite mobile communication device according to a fifth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

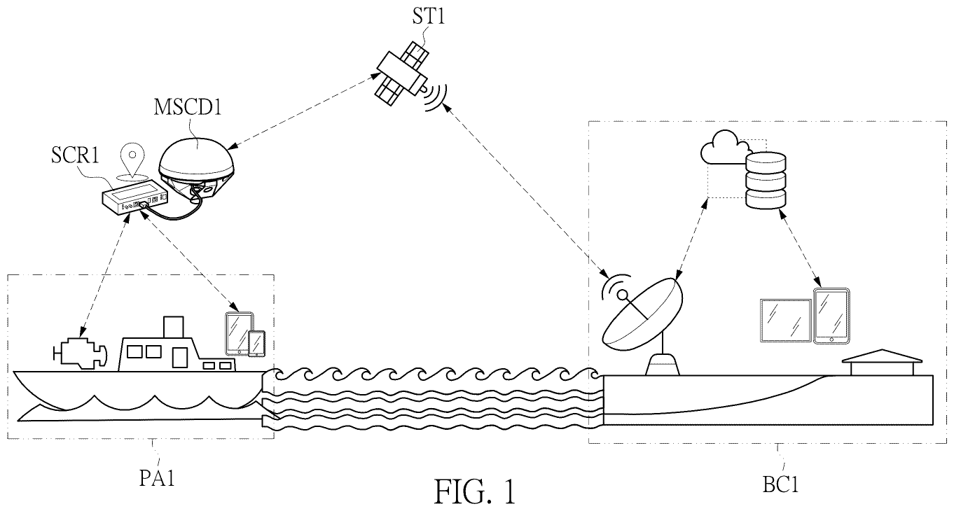

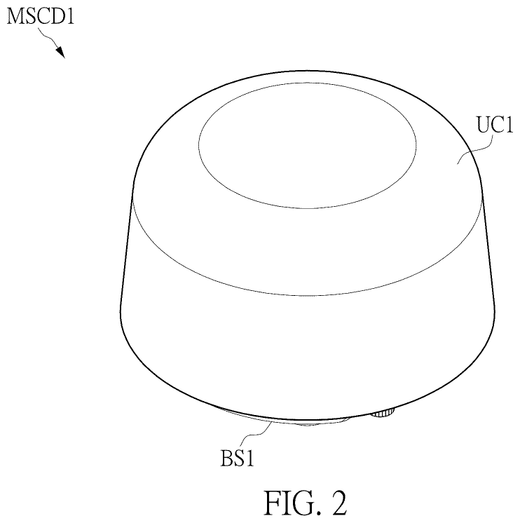

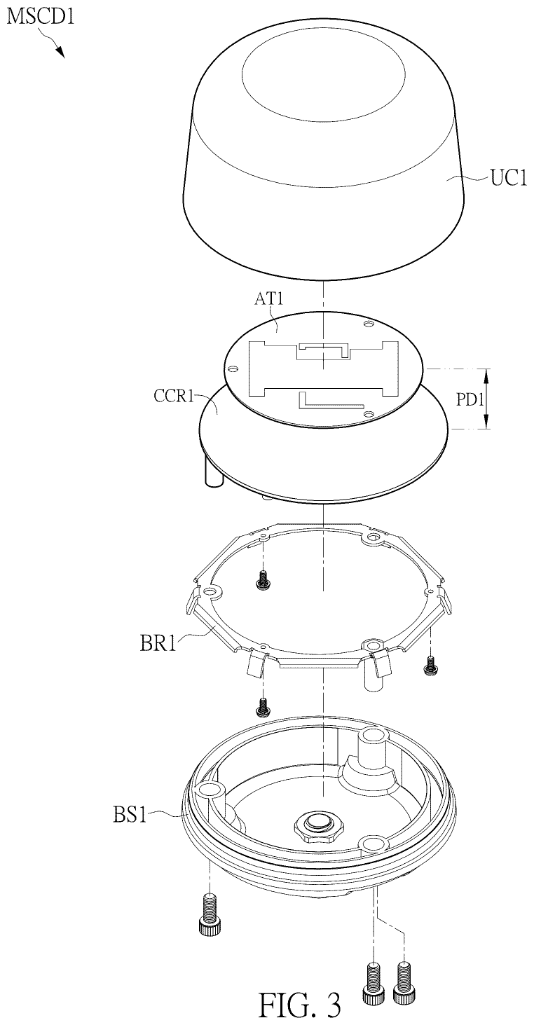

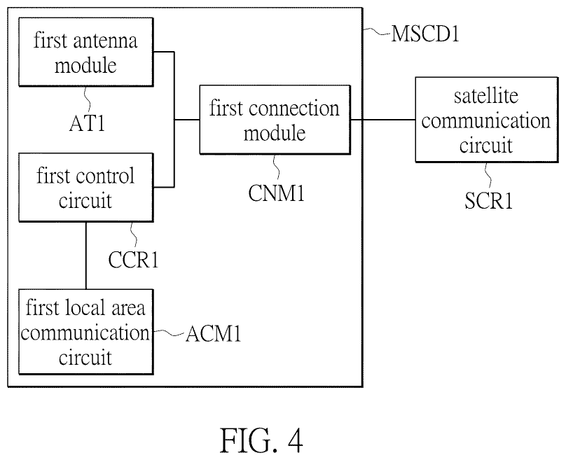

Referring to FIG. 1 to FIG. 4, FIG. 1 is a schematic view of a satellite communication system that cooperates with a satellite mobile communication device according to a first embodiment of the present disclosure, FIG. 2 is a schematic view of the satellite mobile communication device according to the first embodiment of the present disclosure, FIG. 3 is a schematic exploded view of the satellite mobile communication device according to the first embodiment of the present disclosure, and FIG. 4 is a block diagram of the satellite mobile communication device according to the first embodiment of the present disclosure.

The present embodiment provides a satellite mobile communication device MSCD1 for receiving a satellite communication signal of a satellite ST1. The satellite ST1 is connected to an external communication apparatus BC1.

The satellite mobile communication device MSCD1 is connected to a satellite communication circuit SCR1. The satellite mobile communication device MSCD1 includes a base seat BS1, a first control circuit CCR1, a first antenna module AT1, a first connection module CNM1, and a top cover UC1. The first control circuit CCR1 is disposed on the base seat BS1.

The first antenna module AT1 is disposed on a side of the first control circuit CCR1, and is electrically connected to the first control circuit CCR1.

The first connection module CNM1 is connected to the first control circuit CCR1. A first predetermined distance PD1 is defined between the first control circuit CCR1 and the first antenna module AT1.

The top cover UC1 is disposed on the base seat BS1. In the present embodiment, the top cover UC1 is detachably disposed on the base seat BS1. The first connection module CNM1 is connected to the satellite communication circuit SCR1.

In the present embodiment, the first control circuit CCR1 and the first antenna module AT1 are separately disposed on different circuit boards. In addition, the first predetermined distance PD1 between the first control circuit CCR1 and the first antenna module AT1 is greater than or equal to 30 mm (which can be, for example but not limited to, 35 mm).

In the present embodiment, the first connection module CNM1 is an RS-485 connection interface. The satellite mobile communication device MSCD1 is disposed at a fixed position, on a mobile vehicle, or on a vessel. The top cover UC1 is a hollow housing.

The satellite mobile communication device MSCD1 further includes a global positioning system circuit (not shown in the drawing) for detecting positioning information of the satellite mobile communication device MSCD1. The global positioning system circuit and the first antenna module AT1 are arranged above the first control circuit CCR1.

The satellite mobile communication device MSCD1 further includes a support BR1. The support BR1 is connected to and disposed on the base seat BS1. The first antenna module AT1 is disposed on one side of the support BR1, and the first control circuit CCR1 is disposed on another side of the support BR1.

In the present embodiment, the first control circuit CCR1 can be further connected to a first local area communication circuit ACM1. The first control circuit CCR1 can transmit the satellite communication signal to other electronic devices (not shown in the drawing) via the first local area communication circuit ACM1. The first local area communication circuit ACM1 is a WI-FI communication unit, a Bluetooth communication unit, a Zigbee communication unit, a LoRa communication unit, a Sigfox communication unit, or an NB-IoT communication unit.

### Second Embodiment

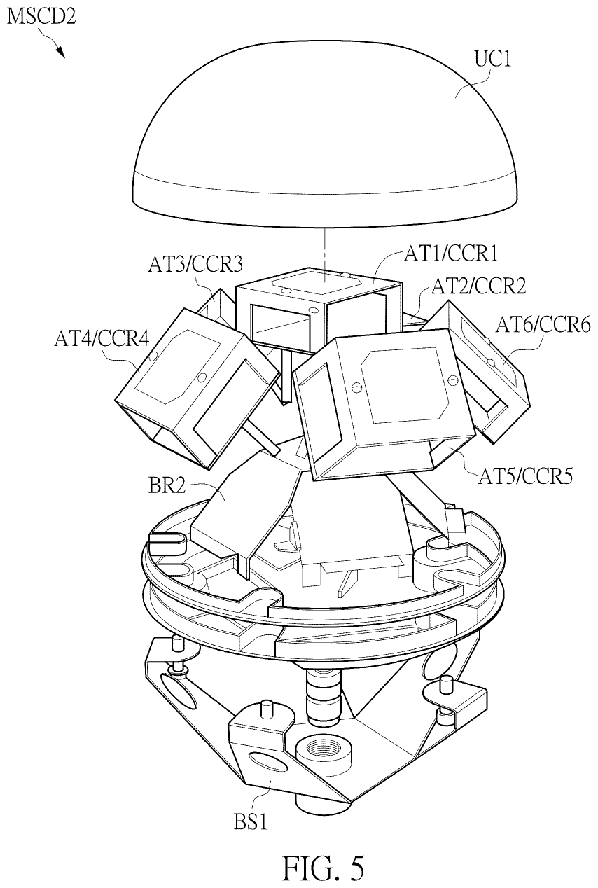

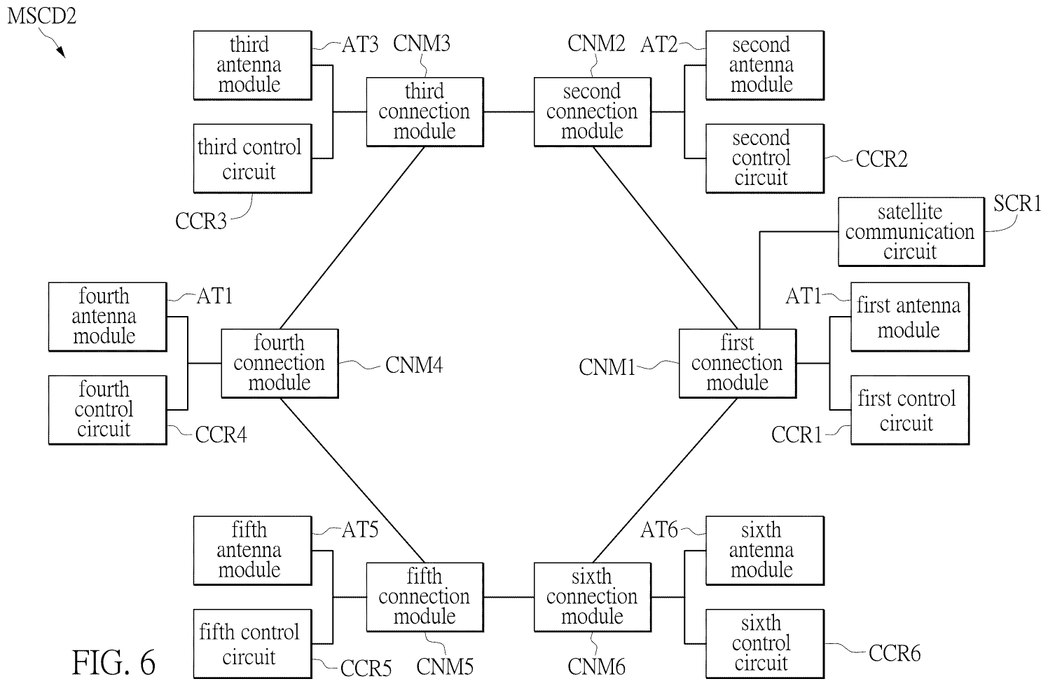

Referring to FIG. 5 and FIG. 6, FIG. 5 is a schematic exploded view of the satellite mobile communication device according to a second embodiment the present disclosure, and FIG. 6 is a functional block diagram of the satellite mobile communication device according to the second embodiment of the present disclosure.

Different from the satellite mobile communication device MSCD1 of the first embodiment, a satellite mobile communication device MSCD2 of the second embodiment includes six antenna modules (AT1 to AT6), six control circuits (CCR1 to CCR6), and corresponding connection modules (CNM1 to CNM6).

The satellite mobile communication device MSCD2 includes an antenna support BR2, the first control circuit CCR1, the first antenna module AT1, a second control circuit CCR2, a second antenna module AT2, a third control circuit CCR3, a third antenna module AT3, a fourth control circuit CCR4, a fourth antenna module AT4, a fifth control circuit CCR5, a fifth antenna module AT5, a sixth antenna module AT6, a sixth control circuit CCR6, the first connection module CNM1, a second connection module CNM2, a third connection module CNM3, a fourth connection module CNM4, a fifth connection module CNM5, and a sixth connection module CNM6. The first antenna module AT1 and the first control circuit CCR1 are arranged above the antenna support BR2. The second control circuit CCR2, the second antenna module AT2, the third control circuit CCR3, the third antenna module AT3, the fourth control circuit CCR4, the fourth antenna module AT4, the fifth control circuit CCR5, the fifth antenna module AT5, the sixth antenna module AT6, and the sixth control circuit CCR6 are disposed at a periphery of an edge of the antenna support BR2.

The first antenna module AT1 is electrically connected to the first control circuit CCR1, the second antenna module AT2 is electrically connected to the second control circuit CCR2, the third antenna module AT3 is electrically connected to the third control circuit CCR3, the fourth antenna module AT4 is electrically connected to the fourth control circuit CCR4, the fifth antenna module AT5 is electrically connected to the fifth control circuit CCR5, and the sixth antenna module AT6 is electrically connected to the sixth control circuit CCR6.

The first connection module CNM1 is electrically connected to the first control circuit CCR1, the second connection module CNM2 is electrically connected to the second control circuit CCR2, the third connection module CNM3 is electrically connected to the third control circuit CCR3, the fourth connection module CNM4 is electrically connected to the fourth control circuit CCR4, the fifth connection module CNM5 is electrically connected to the fifth control circuit CCR5, and the sixth connection module CNM6 is electrically connected to the sixth control circuit CCR6.

In the present embodiment, the first connection module CNM1 is electrically connected to the second connection module CNM2, the second connection module CNM2 is electrically connected to the third connection module CNM3, the third connection module CNM3 is electrically connected to the fourth connection module CNM4, the fourth connection module CNM4 is electrically connected to the fifth connection module CNM5, and the fifth connection module CNM5 is electrically connected to the sixth connection module CNM6. Furthermore, the sixth connection module CNM6 is electrically connected to the first connection module CNM1. That is, the first connection module CNM1, the second connection module CNM2, the third connection module CNM3, the fourth connection module CNM4, the fifth connection module CNM5, and the sixth connection module CNM6 are sequentially connected. As shown in FIG. 6, these connection modules (CNM1 to CNM6) are annularly connected.

In other embodiments, the first connection module CNM1 can be connected to the second connection module CNM2, the third connection module CNM3, the fourth connection module CNM4, the fifth connection module CNM5, and the sixth connection module CNM6 in an arbitrary manner. A connection sequence of these connection modules (CNM1 to CNM6) is not limited to a numbering sequence. While connection can be made according to other sequences, there are no limitations on this in the present disclosure.

The first connection module CNM1, the second connection module CNM2, the third connection module CNM3, the fourth connection module CNM4, the fifth connection module CNM5, and the sixth connection module CNM6 are each the RS-485 connection interface.

Here, only the first control circuit CCR1 and the first antenna module AT1 are exemplified, and descriptions of the structure of other control circuits and antenna modules will not be repeated due to their similarities. The first control circuit CCR1 is disposed on a first control circuit board (not shown in the drawing), and a ground path (not shown in the drawing) having a large area is disposed on a side of the first control circuit board (not shown in the drawing) that faces the first antenna module AT1.

In the present embodiment, according to an information amount of the satellite communication signal of the satellite ST1, the satellite communication circuit SCR1 determines whether the first antenna module AT1, the second antenna module AT2, the third antenna module AT3, the fourth antenna module AT4, the fifth antenna module AT5, and the sixth antenna module AT6 are each operated in an uplink channel mode or a downlink channel mode. That is, in the present embodiment, the satellite communication circuit SCR1 can determine a transmission method (the uplink channel mode or the downlink channel mode) of each antenna module (AT1 to AT6) in the satellite mobile communication device MSCD2.

### Third Embodiment

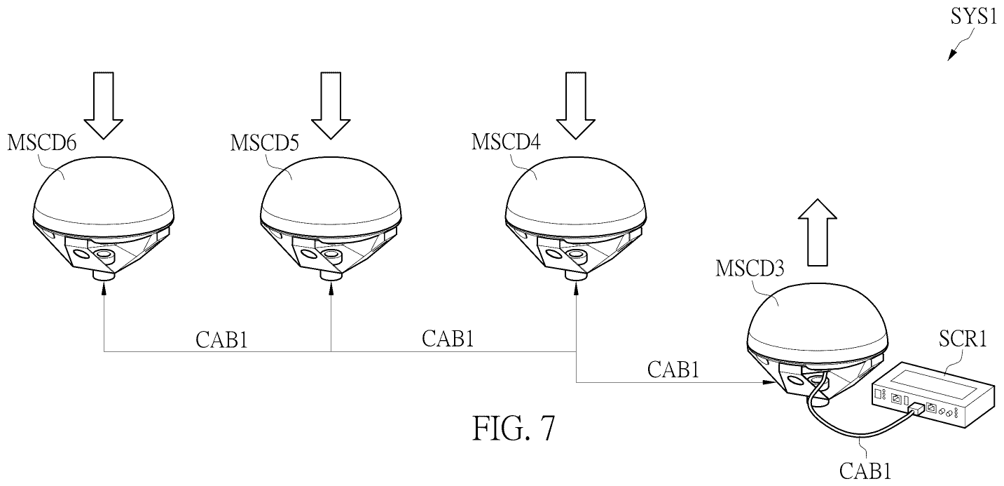

Reference is made to FIG. 7, which is a schematic view of the satellite communication system according to a third embodiment of the present disclosure.

The present embodiment provides a satellite communication system SYS1.

The satellite communication system SYS1 is used for receiving the satellite communication signal of the satellite ST1. The satellite communication system SYS1 includes the satellite communication circuit SCR1, a first satellite mobile communication device MSCD3, a second satellite mobile communication device MSCD4, a third satellite mobile communication device MSCD5, and a fourth satellite mobile communication device MSCD6.

The first satellite mobile communication device MSCD3 is connected to the satellite communication circuit SCR1. The second satellite mobile communication device MSCD4 is connected to the first satellite mobile communication device MSCD3 and the satellite communication circuit SCR1.

The third satellite mobile communication device MSCD5 is connected to the second satellite mobile communication device MSCD4, the first satellite mobile communication device MSCD3, and the satellite communication circuit SCR1.

The first satellite mobile communication device MSCD3, the second satellite mobile communication device MSCD4, the third satellite mobile communication device MSCD5, the fourth satellite mobile communication device MSCD6, and the satellite communication circuit SCR1 are connected to one another via a plurality of connection wires CAB1.

The connection wire CAB1 is an RS-485 communication wire, and includes a power supply wire and a ground wire. The connection wire CAB1 further includes a positive-end signal wire and a negative-end signal wire.

The satellite communication circuit SCR1 supplies power to the first satellite mobile communication device MSCD3, the second satellite mobile communication device MSCD4, the third satellite mobile communication device MSCD5, and the fourth satellite mobile communication device MSCD6 via the connection wires CAB1. The first satellite mobile communication device MSCD3, the second satellite mobile communication device MSCD4, the third satellite mobile communication device MSCD5, and the fourth satellite mobile communication device MSCD6 are disposed at a plurality of positions of a predetermined area PA1. The predetermined area PA1 can be the mobile vehicle, the vessel, or a fixed area.

According to the information amount of the satellite communication signal of the satellite ST1, the satellite communication circuit SCR1 determines whether the first satellite mobile communication device MSCD3, the second satellite mobile communication device MSCD4, the third satellite mobile communication device MSCD5, and the fourth satellite mobile communication device MSCD6 are each operated in the uplink channel mode or the downlink channel mode. In the uplink channel mode, the first satellite mobile communication device MSCD3 to the fourth satellite mobile communication device MSCD6 upload data to the satellite ST1. In the downlink channel mode, the satellite ST1 downloads data to the first satellite mobile communication device MSCD3 to the fourth satellite mobile communication device MSCD6.

According to the information amount of the satellite communication signal of the satellite ST1, the satellite communication circuit SCR1 can further determine whether the antenna modules (AT1 to AT6) in the first satellite mobile communication device MSCD3, the second satellite mobile communication device MSCD4, the third satellite mobile communication device MSCD5, and the fourth satellite mobile communication device MSCD6 are each operated in the uplink channel mode or the downlink channel mode.

In the present embodiment, the quantity of satellite mobile communication devices can be adjusted according to user requirements or an area size, and there are no limitations on this in the present disclosure. That is, the quantity of the satellite mobile communication devices can be two, but can also be four or more. The satellite mobile communication devices are connected to one another via the connection wires CAB1.

Moreover, the satellite mobile communication devices can be connected in a sequential manner, an annular manner, or a network manner, and there are no limitations on this in the present disclosure.

### Fourth Embodiment

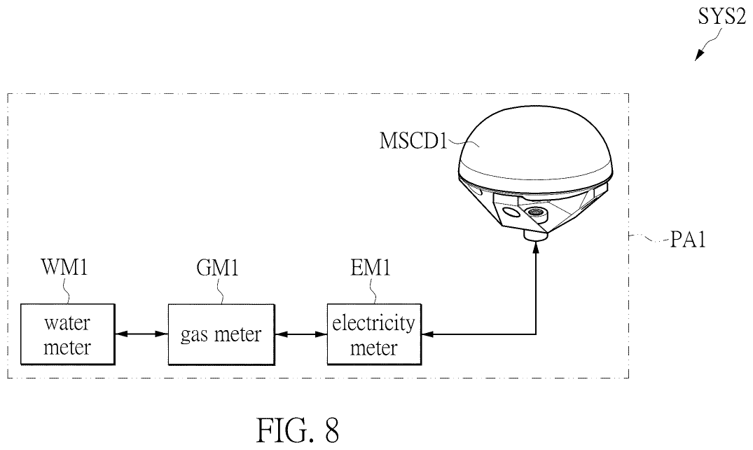

Reference is made to FIG. 8, which is a schematic view of the satellite communication system according to a fourth embodiment of the present disclosure.

A satellite communication system SYS2 includes the satellite mobile communication device MSCD1, an electricity meter EM1, a gas meter GM1, and a water meter WM1.

The satellite mobile communication device MSCD1 is connected to the electricity meter EM1, the gas meter GM1, and the water meter WM1 via the connection wires CAB1. The satellite mobile communication device MSCD1 can use the satellite communication signal to transmit use information of the electricity meter EM1, the gas meter GM1, and the water meter WM1 to corresponding vendor servers.

### Fifth Embodiment

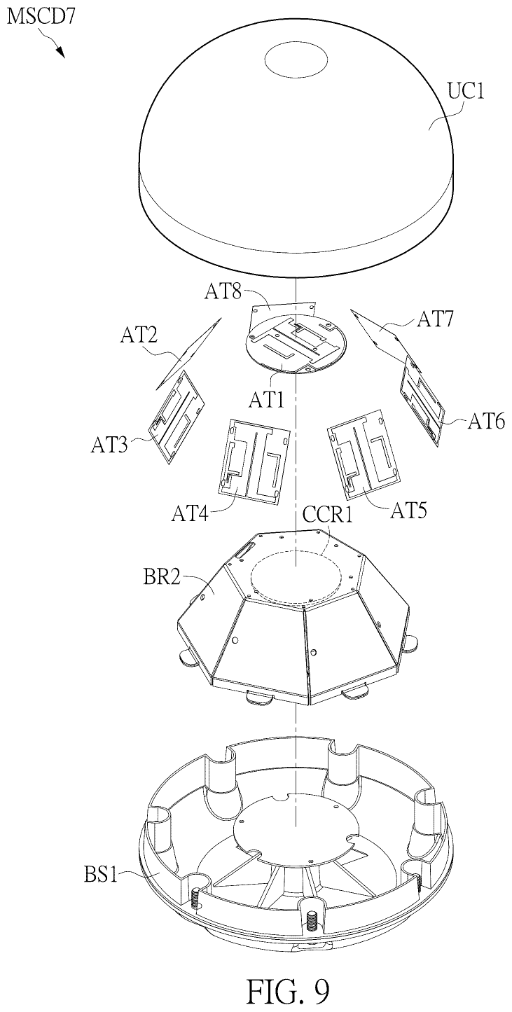

Reference is made to FIG. 9, which is a schematic view of the satellite mobile communication device according to a fifth embodiment of the present disclosure. A satellite mobile communication device MSCD7 at least includes the base seat BS1, the first control circuit CCR1, the first antenna module AT1, the antenna support BR2, and the top cover UC1. In the present embodiment, the first control circuit CCR1 is disposed on the base seat BS1, and the top cover UC1 is disposed on the base seat BS1.

The satellite mobile communication device MSCD7 in FIG. 9 includes eight antenna modules (AT1 to AT8), and is similar to the satellite mobile communication device MSCD1 of the first embodiment. The first antenna module AT1 is disposed on a top side of the antenna support BR2. The second antenna module AT2, the third antenna module AT3, the fourth antenna module AT4, the fifth antenna module AT5, the sixth antenna module AT6, a seventh antenna module AT7, and an eighth antenna module AT8 are disposed at a periphery of the antenna support BR2. The satellite mobile communication device MSCD7 further includes a first connection module (not shown in the drawing). The first control circuit CCR1 of the satellite mobile communication device MSCD7 uses the first connection module (not shown in the drawing) to be connected to a satellite communication circuit (not shown in the drawing), so as to receive a satellite communication signal of a satellite. Control circuits that correspond to other ones of the antenna modules are connected to the first connection module (not shown in the drawing) via corresponding connection modules, so as to be connected to the satellite communication circuit (not shown in the drawing).

Furthermore, the connection modules of the present embodiment are each the RS-485 connection interface. The satellite mobile communication device MSCD7 is similar to the above-mentioned satellite mobile communication devices, and can transmit the power via the connection modules and connection wires of the embodiments.

### Beneficial Effects of the Embodiments

In conclusion, the satellite mobile communication device and the satellite communication system provided by the present disclosure can effectively reduce implementation costs for mobile satellite communication. The satellite mobile communication device can determine one of a plurality of antennas to receive a satellite signal of a satellite through three-dimensional arrangement of the antennas and calculation of antenna signal intensities of the antennas. Furthermore, through implementation of multiple satellite mobile communication devices, the satellite communication system of the present disclosure can determine whether each satellite mobile communication device cooperatively controls communication transmission of a mobile communication system in an uplink channel mode or a downlink channel mode, so as to improve communication efficiency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A satellite mobile communication device for receiving a satellite communication signal of a satellite, the satellite mobile communication device being connected to a satellite communication circuit, and the satellite mobile communication device comprising:
a base seat;
a first control circuit disposed on the base seat;
a first antenna module disposed on a side of the first control circuit, wherein the first antenna module is electrically connected to the first control circuit;
a first connection module connected to the first control circuit, wherein a first predetermined distance is defined between the first control circuit and the first antenna module; and
a top cover disposed on the base seat;
wherein the first connection module is connected to the satellite communication circuit.

2. The satellite mobile communication device according to claim 1, wherein the first connection module is an RS-485 connection interface, the satellite mobile communication device is disposed at a fixed position or on a mobile vehicle, the top cover is a hollow housing, the satellite mobile communication device further includes a global positioning system circuit for detecting positioning information of the satellite mobile communication device, and the global positioning system circuit and the first antenna module are arranged above the first control circuit.

3. The satellite mobile communication device according to claim 2, further comprising:
a support connected to the base seat, wherein the first antenna module is disposed on one side of the support, the first control circuit is disposed on another side of the support, and the first predetermined distance is greater than or equal to 30 mm.

4. The satellite mobile communication device according to claim 2, further comprising:
an antenna support disposed on the base seat, wherein the first antenna module and the first control circuit are arranged above the antenna support;
a second control circuit;
a second antenna module disposed on a side of the second control circuit and disposed on the antenna support, wherein the second antenna module is electrically connected to the second control circuit;
a second connection module electrically connected to the second control circuit;
a third control circuit;
a third antenna module disposed on a side of the third control circuit and disposed on the antenna support, wherein the third antenna module is electrically connected to the third control circuit;
a third connection module electrically connected to the third control circuit;
a fourth control circuit;
a fourth antenna module disposed on a side of the fourth control circuit and disposed on the antenna support, wherein the fourth antenna module is electrically connected to the fourth control circuit;
a fourth connection module electrically connected to the fourth control circuit;
a fifth control circuit;
a fifth antenna module disposed on a side of the fifth control circuit and disposed on the antenna support, wherein the fifth antenna module is electrically connected to the fifth control circuit;
a fifth connection module electrically connected to the fifth control circuit;
a sixth control circuit;
a sixth antenna module disposed on a side of the sixth control circuit and disposed on the antenna support, wherein the sixth antenna module is electrically connected to the sixth control circuit; and
a sixth connection module electrically connected to the sixth control circuit;
wherein the second control circuit, the second antenna module, the third control circuit, the third antenna module, the fourth control circuit, the fourth antenna module, the fifth control circuit, the fifth antenna module, the sixth control circuit, and the sixth antenna module are disposed at a periphery of the antenna support;
wherein the first connection module is electrically connected to the second connection module, the third connection module, the fourth connection module, the fifth connection module, and the sixth connection module; and
wherein the first connection module, the second connection module, the third connection module, the fourth connection module, the fifth connection module, and the sixth connection module are each the RS-485 connection interface.

5. The satellite mobile communication device according to claim 4, wherein the first control circuit includes a first control circuit board, and a ground path is disposed on a side of the first control circuit board of the first control circuit that faces the first antenna module.

6. The satellite mobile communication device according to claim 5, wherein the satellite mobile communication device is connected to the satellite communication circuit, and the satellite communication circuit determines whether the first antenna module, the second antenna module, the third antenna module, the fourth antenna module, the fifth antenna module, and the sixth antenna module are each operated in an uplink channel mode or a downlink channel mode according to an information amount of the satellite communication signal of the satellite.

7. A satellite communication system for receiving a satellite communication signal of a satellite, comprising:
a satellite communication circuit;
a first satellite mobile communication device connected to the satellite communication circuit; and
a second satellite mobile communication device connected to the first satellite mobile communication device and the satellite communication circuit;
wherein, according to an information amount of the satellite communication signal of the satellite, the satellite communication circuit determines whether the first satellite mobile communication device and the second satellite mobile communication device are each operated in an uplink channel mode or a downlink channel mode.

8. The satellite communication system according to claim 7, wherein the first satellite mobile communication device, the second satellite mobile communication device, and the satellite communication circuit are connected to one another via a plurality of connection wires.

9. The satellite communication system according to claim 8, wherein each of the plurality of connection wires is an RS-485 communication wire, and at least includes a power supply wire and a ground wire.

10. The satellite communication system according to claim 9, wherein the satellite communication circuit supplies power to the first satellite mobile communication device and the second satellite mobile communication device via the plurality of connection wires, the first satellite mobile communication device and the second satellite mobile communication device are disposed at a plurality of positions of a predetermined area, and the predetermined area is a mobile vehicle, a fixed area, or a vessel.

11. The satellite communication system according to claim 10, wherein the first satellite mobile communication device is connected to the satellite communication circuit for transmitting the satellite communication signal received by a plurality of antenna modules in the first satellite mobile communication device or the second satellite mobile communication device to the satellite communication circuit, and the satellite communication circuit supplies the power to a plurality of satellite mobile communication devices via a first connection wire.

12. The satellite communication system according to claim 11, wherein, according to the information amount of the satellite communication signal of the satellite, the satellite communication circuit determines whether the plurality of antenna modules in the first satellite mobile communication device and the second satellite mobile communication device are each operated in the uplink channel mode or the downlink channel mode.

13. A satellite mobile communication device for receiving a satellite communication signal of a satellite, the satellite mobile communication device being connected to a satellite communication circuit, and the satellite mobile communication device at least comprising:
a base seat;
an antenna support disposed on the base seat;
a first control circuit disposed on the base seat;
a plurality of antenna modules, wherein one of the plurality of antenna modules is disposed on a top side of the antenna support, and other ones of the plurality of antenna modules are disposed at a periphery of the antenna support; and
a top cover disposed on the base seat.
